(19) United States
(12) Patent Application Publication
(10) Pub. No.: US 2006/0103548 A1
(43) Pub. Date: May 18, 2006

(54) Current sensing bar

(75) Inventors: Timothy J. Borkowski, Houston, TX (US); Richard L. Grasshoff, Richmond, TX (US); R. Kenneth Murphy, Sugar Land, TX (US); Donato Cortez, Sugar Land, TX (US)

Correspondence Address: ALBERT B. KIMBALL, JR.;BRACEWELL & PATTERSON L L P, 711 LOUISANA SUITE 2900, HOUSTON, TX, 77002, US

(73) Assignee: CenterPoint Energy, Inc., Houston, TX (US)

(21) Appl. No.: 11/263,007

(22) Filed: Oct. 31, 2005

Related U.S. Application Data
(60) Provisional application No. 60/624,023, filed on Nov. 1, 2004.
(60) Provisional application No. 60/624,024, filed on Nov. 1, 2004.

(51) Int. Cl. G08C 15/06; G08B 23/00

(52) U.S. Cl. 340/870.02

(57) ABSTRACT

Electrical current in an electrical power distribution system, such as underground residential distribution or the like, is transferred through a current sensing bar from a transformer secondary to separate electrical service connections with residences or other sites of customer power users. The flow of electrical current and thus the amount of electrical power provided to individual users is measured at the current sensing bar rather than at the user's site or facility. This removes the need for watt-hour measurements at the user or customer site, and also thus removes the requirement for conventional meter reading crews or for automated meter reading equipment.

### REFERENCE TO RELATED APPLICATIONS

This application claims the benefit of U.S. Provisional Patent Applications Ser. Nos. 60/624,023 and 60/624,024, each of which was filed Nov. 1, 2004.

### BACKGROUND OF THE INVENTION

1. Field of the Invention

The present invention relates to sensing the amount of current flow in connection with metering or measuring of electrical energy usage for collection and communication of electrical power usage data.

2. Description of the Related Art

So far as is known, the most common method for determining the amount of electricity delivered to a consumer has been to read an electric utility meter (usually measuring kilowatt hours), which was mounted on the home or building of the consumer being served. This arrangement was also usually comparable for both gas and water meters as well, with separate usage meters for each of the commodities provided by those utilities being located on or near the building or property being served. Service charges for those commodities were based on the amounts used, as indicated by the various meters. Because the various utility meters were located at a point where the utility commodity was delivered to the consumer, it became necessary for utility companies to establish routes composed of a number of user locations. A “meter reader” then periodically visited each meter for a utility on a particular route to record the amount of utility product consumed. The consumer was then periodically billed according to measured utility usage.

At present, many utility companies (including gas, electric, and water) have continued to send meter readers to consumer residences or buildings to collect utility meter readings. However, there are practical limitations on how efficiently this procedure can actually be performed. Personnel and staffing costs of meter reading crews became a concern as the numbers of users increased. Also, since security is a major concern of most homeowners today, access to the actual location of the consumer's meters has heightened security issues with consumer and utilities. Some consideration has thus been given to requesting that consumers themselves read their usage meters and periodically report usage readings for billing purposes. This, however, gives rise to other concerns. For instance, most consumers have little or no knowledge on how to read their meters, or how to gain access to meters themselves. This directly and adversely impacted the accuracy and efficiency of the self-reporting process.

The typical process of collecting meter data in the manner now in use thus had numerous disadvantages and inefficiencies. Collection of meter data was a labor intensive and costly process. Widespread use was made of electromechanical metering devices which were less expensive than electronic meters. However, electromechanical metering devices generally had little or no communication capability.

There was some thought and effort towards conversion to an automated meter reading (or AMR) system to overcome some of the problems discussed above. However, for AMR applications, electric utilities were still dependent on a meter device coupled with the service entrance on a home, apartment or business. The coupling arrangement for AMR applications typically made the utility meters electronically accessible, either to a meter reading device or by LAN line connections. However, the various individual meters still had to be read individually for automated meter reading or AMR. Thus, in AMR applications, an additional meter reading/communication device, such as a telemetry device in the form of a meter interface unit or telemetry interface unit was required. The meter reading/telemetry device had to serve as an interface between the two different environments: one being of the meter and one for the receipt and processing of usage data, and subsequent billing. This process has still not been widely used by most utilities because it is cost prohibitive in its adaptation and had mainly a limited, one-way communication, that of reporting usage read from a meter to some data processing center or site for processing and billing.

### SUMMARY OF THE INVENTION

Briefly, the present invention facilitates a new and improved power distribution and sensing apparatus which provides electrical power to customer sites and measures energy usage by the customer sites. The current sensing bar connects the electric power for the customer sites and a service conductor for each of the customer sites. The service conductor for each customer site extends between the current sensing bar and the customer site. An electrical energy usage sensor obtains data indicating the amount of power provided from the current sensing bar through the service conductor to the customer site. A cover may be provided to enclose the connection between the service conductor and the current sensing bar.

The present invention also facilitates a new and improved method of collection of utility usage data of electrical energy service by a customer site from a current sensing bar connected to a power distribution system.

### BRIEF DESCRIPTION OF THE DRAWINGS

A better understanding of the present invention can be obtained when the detailed description set forth below is reviewed in conjunction with the accompanying drawings, in which:

FIG. 1 is a schematic diagram of an electrical power service arrangement for delivery of electrical energy and sensing of energy usage with a current sensing bar according to the present invention.

FIG. 2 is an isometric drawing of a current sensing bar according to the present invention.

FIGS. 3 and 4 are enlarged isometric views, taken partly in cross-section, of portions of the current sensing bar of FIG. 2.

To better understand the invention, we shall carry out the detailed description of some of the modalities of the same, shown in the drawings with illustrative but not limited purposes, attached to the description herein.

### DETAILED DESCRIPTION

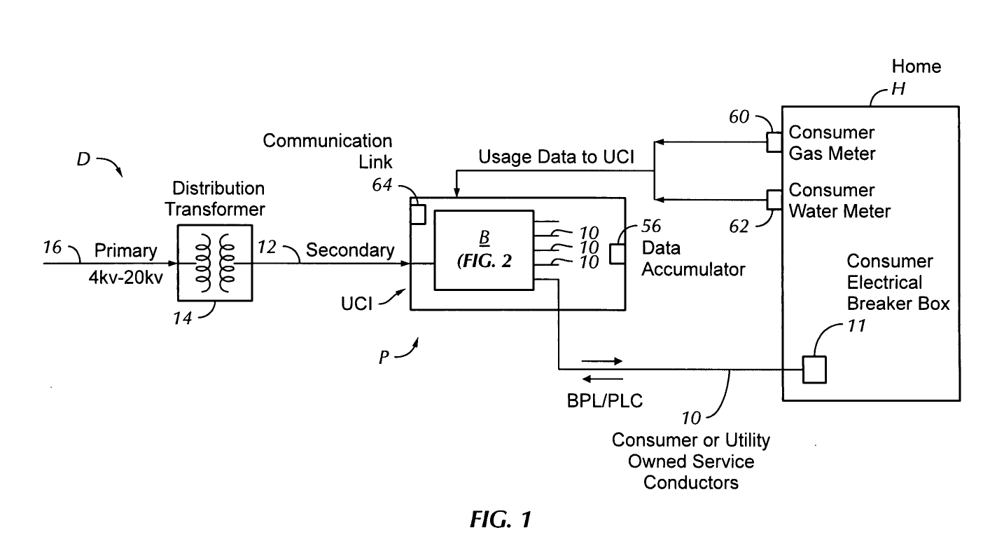

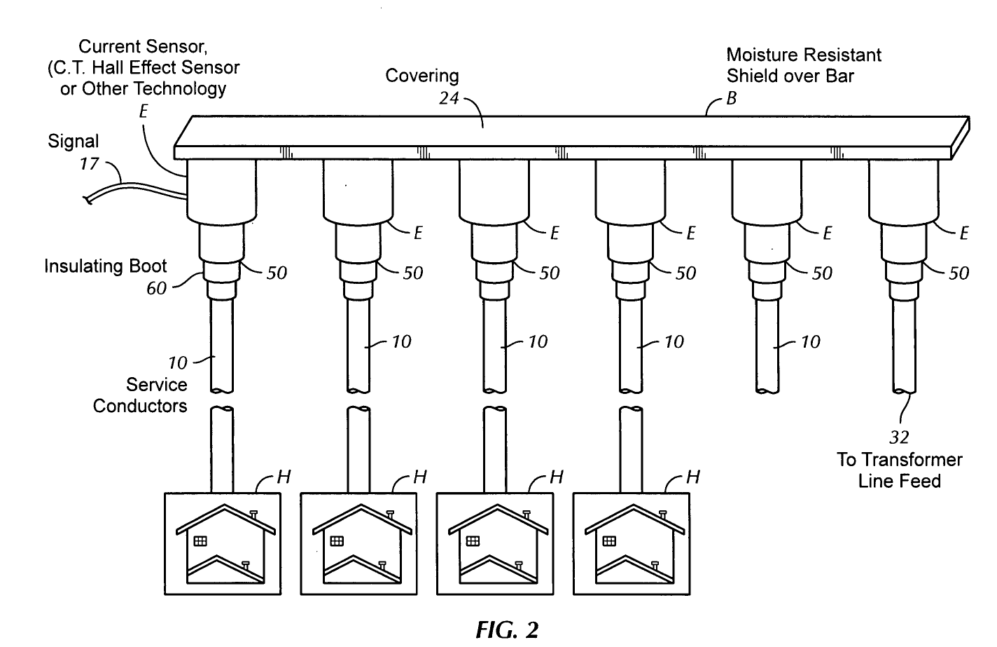

In the drawings, the letter P (FIG. 1) designates generally a power distribution and sensing apparatus according to the present invention which provides electrical energy service to customer sites through a power distribution bar B with current sensing. The customer sites receiving power are shown in FIGS. 1 and 2 as a number of homes H. It should be understood that the sites receiving power from the power distribution and sensing apparatus P and the current sensing bar B may be buildings, factories, apartments or any other facility or location receiving electrical power for use. Accordingly, the owner, occupants of such sites or other recipients of the electrical power being distributed are referred to as customers or users.

The current sensing bar B (FIGS. 1-4) is connected through a service conductor 10 which extends between the bar B and one or more customer sites H in order to transfer electrical energy, typically through a conventional electrical breaker box 11 at the site or sites H. The current sensing bar B is also connected over a secondary distribution line 12 to a distribution transformer 14. The distribution transformer is connected to a primary distribution line 16 of a distribution arrangement D (FIG. 1). In the embodiment of FIG. 1, the distribution arrangement D is an underground residential distribution or URD arrangement, and the primary distribution line 16 transports energy at a primary voltage, for example 7.2 kilovolts or 19.92 kilovolts, to the distribution transformer 14.

The distribution transformer 14 transforms the voltage provided to a customary or typical secondary voltage level, for example 120 volts. The power from the transformer 14 at the customary secondary voltage is transferred by the secondary distribution line 12 to apparatus P and distribution bar B. In the underground residential distribution arrangement D (FIG. 1), the unit UCI can be integrated into a conventional secondary pedestal or mounted in proximity to the URD transformer.

The unit UCI may be mounted so that it is directly connected to the URD transformer, or alternatively on or with the same pad or other support structure and in electrical connection with the URD or other transformer through a conductor. In any of the foregoing situations, the location of the unit UCI and the transformer are to be considered in proximity to each other according to the present invention.

In the preferred embodiment, the power distribution and sensing apparatus B is a component of a usage and data collection unit UCI of the type described and disclosed in commonly owned, co-pending U.S. patent application Ser. No. 11/153,304, filed Jun. 15, 2005. As disclosed in that application, the usage and data collection unit UCI obtains utility usage data in electrical power service plus other utility data. In addition, Broadband and other communications services are provided to one or more consumers as shown schematically in FIG. 1. The unit UCI shown schematically in FIG. 1 is shown schematically for an underground residential distribution or URD power distribution arrangement.

It should also be understood that the unit UCI of the present invention may be used in connection with an overhead distribution arrangement or other power distribution arrangement. The unit UCI of the present invention serves to integrate the data collection and reporting of utility usage data from electric and other utilities data. Also, Broadband and other communications services are provided to one or more consumers as shown schematically in FIG. 1.

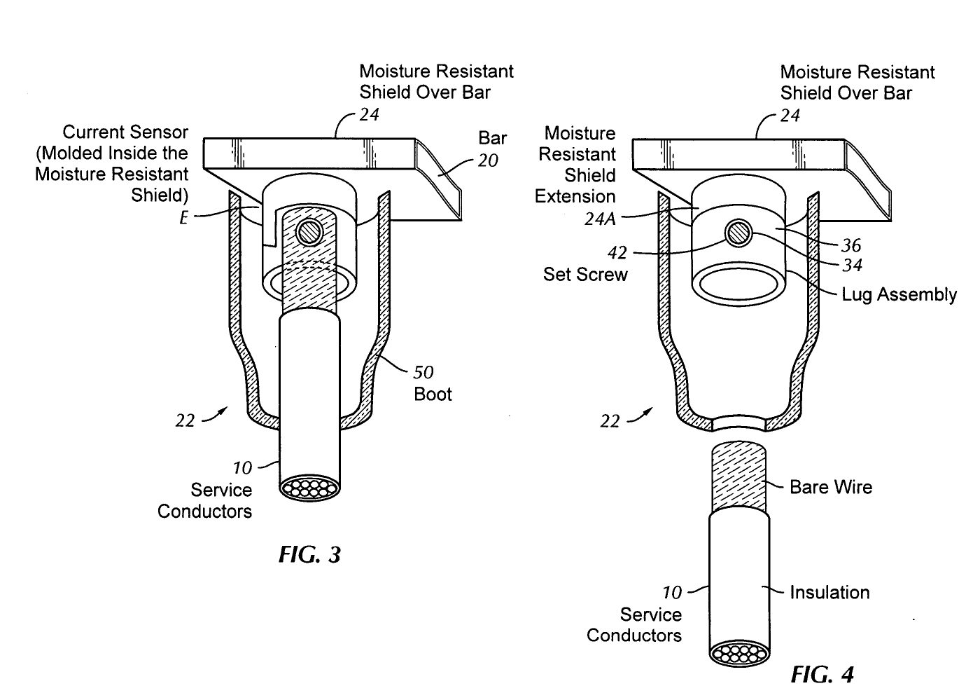

The current sensing bar B is provided with an electrical current sensor E (FIG. 2) which obtains data readings indicating the amount of electric current provided to the customer site or sites H over the respective service conductor 10 associated with such site. The current sensing bar B of the power distribution and sensing apparatus P takes the form (FIGS. 3 and 4) of a conductive bus or bar 20 of a material of required conductivity, such as copper, aluminum or some suitable alloy thereof. The bus or bar 20 is connected through the secondary power distribution conductor 12 (FIG. 2) to the distribution transformer 14. The bus or bar 20 may also be directly connected to the transformer 14, if desired. The bus or bar 20 also has formed or connected therewith a set of current carrying lugs or connector sockets 22 of a suitable number, to which electrical connection can be made by individual service conductors 10. A typical number of connector sockets 22 for instance might be four, six or eight. The conductive bus 20 is normally enclosed within a protective, moisture resistant sleeve or shield 24.

The current sensing bar B also includes a number of current sensors E (FIG. 2), corresponding in number to the number of users or sites for whom it is desirable to obtain data indicating the amount of current usage being provided.

The electrical current sensor E of the present invention preferably take the form of a current flow sensor arranged on each one of the service conductors 10 for each individual user or site. The current sensors E may take the form of a current transformer to indicate sensed current flow through the service conductor, or a Hall effect sensor operating based on the Hall effect to generate a signal proportional to the amount of current flowing to the individual user. It should be understood that other types of current flow sensors of energy measuring sensors or transducers may also be used to sense electrical energy furnished to the users and consumers.

The current sensors E transmit readings indicating at times of interest the amount of current sensed as flowing into the various service conductors 10 which have current sensors E associated therewith. The amount of current to an individual consumer or user flowing over time to a customer, combined with the voltage level at which the current is provided, is an accepted indication of energy consumed, since the voltage level is measured by a voltage device.

In FIG. 3, the electrical current sensors E are each mounted with one of the conductor connector sockets or lugs 22 in the area of connection of such lugs with the bus or bar 20. The current sensors E are encapsulated or molded within an extension 24a of the moisture resistant shield 24 which encloses the conductive bar 20. A service conductor connector lug 22 (FIGS. 1 and 4) of the current sensing bar B is provided to receive a service conductor 10. connected in a like manner.

In FIG. 4, each of the connecter lugs 22 has a connector port or socket 34 formed in a side wall 36 thereof. A bare wire end of the service conductor is then fitted as shown in FIG. 4 into the interior of socket 34 of lug 22 within side wall 36. A set screw or other suitable connector 42 is inserted into socket 34 and tightened down to firmly connect the bare service conductor 10 with the lug 22 and current sensing bar 20 for flow of electrical current. The connections between the service conductors 10 and the current sensing bar 20 are covered within an insulating boot 50 of rubber or other comparable material such as a suitable insulative elastomer.

In FIG. 1, when the apparatus P and current sensing bar B are thus installed and connected to the required service conductors 10, readings from the individual electrical energy users are furnished to a meter data accumulator 66 (FIG. 1) which stores the electrical energy usage data provided to the user/consumer from the distribution transformer 14. In FIG. 2, the electrical current sensor E is providing electrical usage data to the meter data accumulator in the unit UCI in the manner disclosed in applicants' commonly owned, co-pending U.S. patent application referenced below. Typically, electrical energy is also provided, as also disclosed in that co-pending application, to the meter data accumulator and other components of the unit UCI.

The unit UCI is preferably of the type according to co-pending commonly owned U.S. patent application Ser. No. 11/153,304, and is thus also adapted to gather utility data for gas and water utility services from meters 60 and 62, in addition to electrical energy usage with current sensors E. The current sensor E for each individual consumer/user is connected in the unit UCI which converts the readings of current flow to the consumer, and thus energy usage, into a signal. Signals are provided as current flow readings and thus electrical energy readings for storage in an accumulator memory or storage register of the meter data accumulator 66 in the unit UCI. The storage register accumulates readings of energy usage versus elapsed time and forms an indication of such usage. In the meter data accumulator memory of the unit UCI, a user identifier code or prefix unique to the user or consumer being served is also added or included as an identifier to the usage data.

The integrated metering data may be sent by way of a communications link 64, as disclosed in the commonly owned, co-pending application previously referenced. The data from the unit UCI may be sent using a variety of telecommunication technology media, such as: wire; coaxial cable, fiber optic cable or other cable media; BPL or broad band powerline carrier; PLC or power line carrier; or WIFI (Wireless Fidelity); and the like. Wireless communications may also be used.

When power line carrier communication of certain types is used, BPL/PLC converters/injectors (hop-on connectors) are provided to transfer the meter usage data and other signals to the electrical utility conductors. The telecommunications technology provided for data readings transmission also makes available interactive communication between the consumer and the utilities through the unit UCI. Finally, the unit UCI serves through the telecommunications technology of the foregoing types as the point of communication for the consumer's Broadband services such as CATV, telephone or ISP.

From the foregoing, it can be seen that the present invention is adapted for use in connection with a variety of power applications and with a variety of arrangements for furnishing electrical power to a consumer or user's facility.

With the present invention, the unit UCI and current sensing bar B may be used in connection with underground residential power distribution arrangement, or with a pole mounted unit in connection with overhead electrical power distribution arrangements, or with other power distribution arrangements. Additionally, the unit UCI of the present invention may be provided as a wall-mounted unit to facilities such as apartment buildings where there are multiple users, each requiring separate and individual billing service. With such an arrangement, individual current flow sensors E of the sensing bar B are provided by the unit UCI for each of the separate residents of the building or facility requiring separate billing. However, it is to be noted that there is no meter that needs to be read for any such user. Rather, the unit UCI of the present invention transmits the data readings to a data collection facility as used for individual users for billing purposes and there is no need for conventional meter readings to take place.

The invention has been sufficiently described so that a person with average knowledge in the matter may reproduce and obtain the results mentioned in the invention herein Nonetheless, any skilled person in the field of technique, subject of the invention herein, may carry out modifications not described in the request herein, to apply these modifications to a determined structure, or in the manufacturing process of the same, requires the claimed matter in the following claims; such structures shall be covered within the scope of the invention.

It should be noted and understood that there can be improvements and modifications made of the present invention described in detail above without departing from the spirit or scope of the invention as set forth in the accompanying claims.

That which is claimed is:

1. A power distribution and sensing apparatus connecting electrical power service to customer sites and separately measuring energy usage by the customer sites, comprising:
a current sensing bar connecting electrical power for the customer sites;
a service conductor connected to the current sensing bar and extending between the current sensing bar and a customer site and transferring electrical energy to the customer site; and
an electrical current sensor obtaining data indicating the amount of energy provided from the current sensing bar via the service conductor to the customer site

2. The apparatus of claim 1, further including:
a cover enclosing the connection between the service conductor and the current sensing bar.

3. The apparatus of claim 2, wherein:
the electrical current sensor is mounted under the cover.

4. The apparatus of claim 1, wherein the cover comprises an insulating boot.

5. The apparatus of claim 1, wherein the electrical power service is by underground distribution through a secondary distribution transformer connected to the current sensing bar.

6. The apparatus of claim 1, wherein the electrical current flow sensor measures the flow of electrical current in the service conductor.

7. The apparatus of claim 6, wherein the electrical current flow sensor comprises a Hall effect current sensor.

8. The apparatus of claim 6, wherein the electrical current flow sensor comprises a current transformer.

9. The apparatus of claim 1, wherein electric utility usage data is obtained of electrical power service provided to a plurality of consumers, and further including:
a plurality of electrical power usage sensors, each obtaining data indicating the amount of power flowing through a separate service conductor to a selected one of the plurality of consumers.

10. The apparatus of claim 1, further including a moisture shield cover enclosing the current sensing bar.

11. The apparatus of claim 1, further including a signal transfer means for providing data from the electrical power usage sensor for processing.

12. The current sensing lug of claim 11, wherein the signal transfer means comprises a wireless signal transfer means.

13. The current sensing lug of claim 11, wherein the signal transfer means comprises a wired signal transfer means.

14. The apparatus of claim 1, wherein the current sensing bar is connected to receive electrical power from a secondary voltage line of a power distribution system.

15. The apparatus of claim 14, wherein the current sensing bar is connected to a power distribution transformer.

16. The apparatus of claim 14, wherein the current sensing bar is connected to an underground residential power distribution system.

17. The apparatus of claim 14, wherein the current sensing bar is connected to an overhead distribution system.

18. The apparatus of claim 1, wherein the service conductor extends between an end portion connected to the current sensing bar and an end portion connected to a customer site.

19. The apparatus of claim 18, wherein the electrical current sensor is mounted with the end portion of the service connector connected to the current sensing bar.

20. A method of collection of utility usage data of electrical power service by a customer site from a current sensing bar connected to a power distribution system, comprising the steps of:
providing electrical power from the current sensing bar to the customer site over a service conductor connected to the current sensing bar; and
obtaining data indicating the amount of energy provided through the service conductor at the connection to the current sensing bar.

21. The method of claim 20, wherein the step of obtaining data comprises the step of measuring the flow of electrical current in the service conductor at the connection to the current sensing bar.

22. The method of claim 21, wherein the step of measuring the flow of electrical current is performed with a Hall effect current sensor.

23. The method of claim 21, wherein the step of measuring the flow of electrical current is performed with a current transformer.

24. The method of claim 21, wherein utility usage data is obtained of electrical power service provided to a plurality of customer sites separately connected individually to the current sensing bar by service conductors, and wherein the step of obtaining data comprises the step of:
obtaining data indicating the amount of energy provided to different ones of the plurality of customer sites through their respective service conductors.
